(19) United States
(12) Patent Application Publication
(10) Pub. No.: US 2008/0032844 A1
(43) Pub. Date: Feb. 7, 2008

(54) Quasi Continuous, Positive Fit Satellite Gear Mechanism

(76) Inventor: Herwig Fischer, Willich (DE)

Correspondence Address: K.F. ROSS P.C., 5683 RIVERDALE AVENUE, SUITE 203 BOX 900, BRONX, NY, 10471-0900, US

(21) Appl. No.: 10/587,812

(22) PCT Filed: Jan. 28, 2005
(86) PCT No.: PCT/EP05/00851

§ 371 Date: Mar. 5, 2007

(30) Foreign Application Priority Data
Jan. 30, 2004 (DE) 10 2004 004 850.9

(51) Int. Cl. F16H 29/18

(52) U.S. Cl. 475/170; 74/117

(57) ABSTRACT

The invention relates to a continuous, positive fit gear mechanism which can be adjusted in a continuous manner by eccentrically offsetting transmissions between an input and an output. Said gear mechanism comprises an adjusting device which is used to control transmission such that, preferably, eccentric positions are adjusted enabling the gear mechanism to be operated in a particularly silent manner, and the peripheral length (17) of the charge arc represents an integral multiple of the positive fit (teeth).

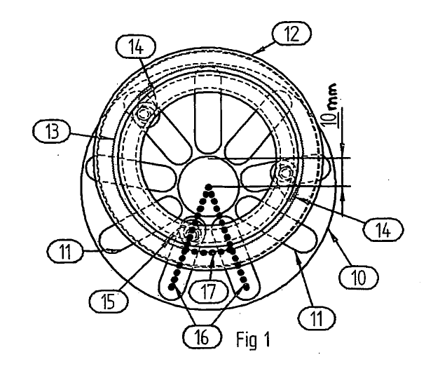

The invention relates to a quasi-continuous, positive mesh planetary-gear transmission comprising an input element and an output element that can assume a plurality of concentric or eccentric positions at varying rotational speeds as a result of displacement, wherein the rotating planetary gears can be coupled cyclically through a load path and in this coupled state directly or indirectly transmit torque from the input element to the output element.

Gear transmissions that allow continuous transmission control with positive mesh gear ratios are disclosed as so-called planetary-gear transmissions for example in EP 0 708 896 B1. This gear transmission comprises several individual gears that together form a planetary gear connected to a central gear in a permanent mesh connection, the ratios of the effective radii of the planet gear and the central gear and the mutual eccentric positions of the planet gear and the central gear, which positions can be varied by using suitable means, determining the ratios of the rotational speeds between the input and output elements. The gears forming the planet gear, when positioned eccentrically to the central gear, pass through a torque-transmitting load path and a load-free path per cycle. The gears are mounted rotatably both about the planet gear axis and via one-way clutches about their own axes, so that during transition from the load-free path to the arcuate load path they are able to transmit the current torque while blocking their own rotation as a result of positive mesh. Fluctuations in the torque transmission are compensated at least in part through cyclical control by varying the effective radii determined by the load path and/or the effective tangential component.

WO 03/060348 A1 discloses a satellite gear transmission that comprises a ring gear with an annular groove as well as a star-shaped body with radial grooves, where the satellites are coupled to the ring gear and torque is transmitted to the star body by means of a coupling pin. In order to reduce or eliminate irregularities by varying the effective radii in the load path, each satellite comprises a radial groove in which the coupling pin can be guided inside the load path at least substantially relative to a center of the ring gear.

One common feature of all planetary-gear transmissions mentioned above is that the input and output elements can be varied arbitrarily in their eccentric positions so that an infinite number of gear ratios can be achieved. The transmission of torque in these gear transmissions is effected by the cyclic coupling or uncoupling of the planetary gears on the periphery of the ring gear, wherein as a result of the directional effect, i.e. the free-running effect, always that planetary gear is coupled that produces the greatest gear ratio. The arcuate load path is defined by the area in which a planetary gear is coupled, while the area in which the respective planetary gear is free-running and runs in the overrunning mode represents the load-free path. The position of the load path is theoretically stationary in the gear transmission and is positioned symmetrically and parallel around the line of the eccentric displacement, as a function of the transmission direction in the or opposite to the displacement direction.

The load path length is defined as the peripheral length on the ring gear that is formed by a segment of the star wheel. The star wheel comprises a plurality of substantially radial segments, the number of which is determined by the number of planetary gears present. In theory, the coupling process occurs when two planetary gears are located in symmetrical positions, i.e. on equal radii.

In eccentric positions like these, in which a planetary gear in symmetrical position to the leading planetary gear fits exactly in one positive mesh element (i.e. a tooth or gear), also in practice the load transfer will take place very close to the theoretical load path entrance. In all cases in which the planetary gear due to the load reversal at the point of symmetry commences the coupling process, i.e. rotates about the coupling pin for engagement, however does not find a tooth gap, this planetary gear has to lead until it reaches the next tooth face.

This overrunning process initially starts with a very low differential speed because for simple geometrical reasons in the vicinity of the load path entrance the speeds of two adjacent planetary gears are initially identical and increase only slowly with progressing rotation. Up to the coupling point that in the most unfavorable case is on the tooth face one tooth width away, depending on the geometry of the gear transmission a differential angle between the input element and the output element is passed that has the same order of magnitude as that of the load path angle. Consequently, in practice a shift of the load path occurs in relation to the theoretical position that is associated with a considerable increase in fluctuation because clearly increased differential speeds develop between the planetary gears. In some eccentric positions, this results in such tremendous speed differentials that the following planetary gear no longer couples and instead the planetary gear after the next one that encounters a more favorable tooth gap directly engages.

Kinematics analyses show that in practically configured gear transmissions with corresponding parameter specifications in terms of the number of planetary gears and teeth, excess fluctuations in the range of 400% occur as a result of the above-mentioned load path shifts, in typical variations for example from 1.5% fluctuation to more than 8%. The fluctuation, which is defined by the number of planetary gears present and which also occurs with the force-fit coupling of the planetary gears, is referred to as the primary fluctuation (in the example above 1.5%). The fluctuation, which is defined by the load path shifts due to unfavorable positions of the teeth, is referred to as the secondary fluctuation (in the above example 8%−1.5%=6.5%).

It is the object of the present invention to create a gear transmission that does not have the above-mentioned disadvantages, i.e. which can be operated with greater running smoothness.

This object is achieved with the measures outlined in claim 1, according to which the load path length defined by the respective eccentric displacements by means of a variable transmission is a whole-number multiple of the tooth width. The invention is based on the consideration that certain eccentric positions or gear ratios of the gear transmission are preferred, namely those at which minimal fluctuations occur, i.e. the secondary fluctuation disappears.

This way, very smoothly running gear transmissions can be produced with only minor additional manufacturing expenses, without having to tolerate practical disadvantages or functional restrictions. In fact in most cases of practical applications, no gear transmissions with an infinite number of gear ratios are required. The claim for “continuous variation” is focused on continuous control without interrupting the torque flow, and without the need for separating clutches or torque converters, as well as on the avoidance of progressive ratios in the drive train. The selection of a constant gear ratio upon completion of the control process for the subsequent stationary operating period therefore certainly allows variation between the desired and the specific gear ratio. The invention minimizes the involvement of planetary-gear transmissions in the operating cycle in that for the stationary mode with an unchanged eccentric position, i.e. a constant gear ratio, a suitable graduated ratchet transmission in the adjustment ensures that the eccentric displacement is carried with values, at which the load path length is at least substantially a whole-number multiple of the tooth pitch.

Preferably, a variable transmission with a graduated ratchet transmission is selected that allows the eccentric positions to be adjusted and locked. In a special embodiment, this can be an adjusting spindle, the pitch of which is set such that two adjoining eccentric positions with whole-number teeth numbers are provided in the load path removed by one spindle revolution or a whole-number multiple of one spindle revolution. In an embodiment of this type, a simple cam ratchet transmission can fix the optimal eccentric positions in the spindle revolution.

According to an alternative embodiment, a sensor is used whose vibration readings serve as adjusting variables for the detailed adjustment of the eccentric positions of the input and output elements at which the greatest running smoothness is achieved. The sensor can be, for example, a knock sensor that is integrated in the control as a structure-carried noise probe, where this sensor does not use the respective geometric positions, but rather the running smoothness determined by the sensor as the control variable for the controller. In principle, however, also other programmable controls can be used for preferred eccentric positions.

According to another embodiment of the invention, the displacement path along which the input and output elements can be moved in order to vary the rotational gear ratio is not linear, with the positions to be actuated, at which the greatest running smoothness is achieved, being preferably equidistant and/or with means being provided to be able to easily detect these positions.

With the planetary-gear transmission disclosed in WO 03/060348 A1 that comprises a ring gear with an annular groove and a star wheel with radial grooves as well as satellites that are coupled to the ring gear, the radial grooves in the star wheel preferably extend along a non-linear contour, thus allowing for easy actuation of the positions with minimal fluctuations, preferably reaching equidistant positions for minimal fluctuations.

According to an alternative embodiment of the invention, the displacement path, along which the input and output elements—i.e. in a special case the ring gear as well as the star wheel—can be displaced, extends in a non-linear fashion and also the course of the radial grooves in the star wheel is non-linear in order to facilitate the actuation of the position with minimal fluctuations.

In order to provide gear ratios with special running smoothness that have high cyclical operating times across the entire load range, a tooth pitch is selected at which the load path length for the preferred gear ratios is a whole-number multiple of the selected tooth pitch. In particular a number of teeth is selected that represents a whole-number multiple of the planetary quantity.

According to a special embodiment of the invention, the geometry of the grooves in the star wheel is adjusted to the geometry of the eccentric displacement such that the number of positions with a whole-number tooth quantity in the load path is maximized and/or that a particularly simple adjusting kinematics is achieved for the graduated ratchet adjustment of the adjusting gear transmission. In particular, the grooves of the star wheel can be arched, and the displacement path can also extend across a special contour in order to achieve the desired properties.

One embodiment of the invention is illustrated in the drawing that shows a schematic view of a planetary-gear transmission.

The only FIGURE shows a star wheel 10 with radial grooves 11 in an eccentric position in relation to a ring gear 12 with teeth 13. The eccentric displacement in the illustrated example is 10 mm. For simplicity reasons, only three planetary gears are shown, of which the two planetary gears 14 are free-running and in the overrunning mode because they run in the load-free path. The illustrated planetary gear 15 is shown in the load path entrance in the locking position. Of course corresponding to the nine radial grooves 11 nine planetary gears are provided.

As the drawing illustrates, the load path is defined by two boundary lines 16 that are positioned symmetrically to the displacement direction of the eccentricity (around 10 mm) and mark the load path entrance and the load path exit. The load path angle is 360°/9=40° for nine planetary gears. When the peripheral length 17 is located inside the load path at the height of the radius on which the teeth 13 is mounted, a whole-number multiple of the tooth peripheral length (about the tooth width) exists, i.e. a whole-number uninterrupted number of teeth inside this zone, the coupling of the subsequent planetary gear is not impaired. The planetary gear is then coupled directly in the vicinity of the load path entrance, and the load path shift and consequently the secondary fluctuation are minimized. All eccentric positions for which this state can be achieved are preferred positions for the gear transmission with optimal running properties.

1. A quasi-continuous, positive mesh planetary-gear transmission, comprising an input element and an output element that can assume a plurality of concentric or eccentric positions at varying rotational speeds as a result of displacement, the rotating planetary gears (14, 15) being coupled cyclically through a load path (17) and in this coupled state directly or indirectly transmitting torque from the input element to the output element,
characterized in that
the load path length defined by eccentric displacements by means of a variable transmission is a whole-number multiple of the tooth width.

2. The planetary-gear transmission according to claim 1, characterized in that the variable transmission comprises a ratchet transmission that allows the eccentric positions to be adjusted and locked.

3. The planetary-gear transmission according to claim 1, characterized by a sensor, the vibration readings of which serve as adjusting variables for the detailed adjustment of the eccentric positions of the input and output elements at which the greatest running smoothness is achieved.

4. The planetary-gear transmission according to claim 1, characterized in that the displacement path, along which the input and output elements can be moved in order to vary the rotational gear ratio, is not linear, with the positions to be actuated, at which the greatest running smoothness is achieved, being preferably equidistant and/or with means being provided to be able to easily detect these positions.

5. The planetary-gear transmission according to claim 1, characterized in that a ring gear (12) with an annular groove and a star wheel (10) with radial grooves (11) as well as planetary gears (14, 15) are provided that are coupled to the ring gear (12), the radial grooves (11) in the star wheel (10) extending along a non-linear contour so that easy actuation of the positions with minimal fluctuations is possible and/or that these positions are positioned in an equidistant manner.

6. The planetary-gear transmission according to claim 1, characterized in that the radial grooves (11) in the star wheel (10) and the displacement paths of the eccentric positions do not extend in a straight manner, but extend in special contours, so that the positions with minimal fluctuations can be easily actuated, preferably achieving equidistant positions for minimal fluctuations.

7. The planetary-gear transmission according to claim 1, characterized in that the number of teeth is adjusted to the number of planetary gears such that the condition of a whole-number load path length is achieved in preferred gear ratios and/or eccentric positions.

8. The planetary-gear transmission according to claim 1, characterized in that the number of teeth is a whole-number multiple of the number of planetary gears.
